(19) United States
(12) Patent Application Publication
(10) Pub. No.: US 2011/0094216 A1
(43) Pub. Date: Apr. 28, 2011

(54) VEHICLE ENERGY HARVESTING DEVICE USING VEHICLE THERMAL GRADIENTS

(75) Inventors: Alan L. Browne, Grosse Pointe, MI (US); Nancy L. Johnson, Northville, MI (US); Nilesh D. Mankame, Ann Arbor, MI (US); James Holbrook Brown, Costa Mesa, CA (US); Geoffrey P. McKnight, Los Angeles, CA (US); Paul W. Alexander, Yspilanti, MI (US)

(73) Assignees: GM GLOBAL TECHNOLOGY OPERATIONS, INC., Detroit, MI (US); HRL Laboratories, Malibu, CA (US)

(21) Appl. No.: 12/685,698

(22) Filed: Jan. 12, 2010

Related U.S. Application Data
(60) Provisional application No. 61/255,397, filed on Oct. 27, 2009.

(51) Int. Cl. F03G 7/06

(52) U.S. Cl. 60/527

(57) ABSTRACT

A vehicle includes an energy harvesting system. The energy harvesting system includes a fluid, a heat engine, and a component. The fluid has a first fluid region at a first temperature and a second fluid region at a second temperature that is different from the first temperature. The heat engine is configured for converting thermal energy to mechanical energy and includes a shape-memory alloy disposed in contact with each of the first fluid region and the second fluid region. The component is driven by the heat engine in response to the temperature difference.

### CROSS-REFERENCE TO RELATED APPLICATIONS

This application claims the benefit of and priority to U.S. Provisional Patent Application No. 61/255,397 filed Oct. 27, 2009, which is hereby incorporated by reference in its entirety.

### TECHNICAL FIELD

The present invention generally relates to a vehicle, and more specifically, to an energy source for the vehicle and vehicle accessories.

### BACKGROUND OF THE INVENTION

Vehicles are traditionally powered by engines which provide drive for the vehicle and batteries, which provide power for starting the engine and for vehicle accessories. Advancements in technology and desire for driver conveniences have led to additional power loads from existing accessory systems as well as additional accessories. The increased power loads have led to greater demand on the vehicle power sources. In addition, a large portion of the power from the vehicle's power sources is lost as heat.

However, arrangements for extending the fuel economy of a vehicle are desirable in light of the growing concern for fuel efficient vehicles. Therefore, arrangements that reduce the power load and/or increase the efficiency of the vehicle's traditional power sources, such as the battery and the engine are desirable.

### SUMMARY OF THE INVENTION

A vehicle includes a first fluid region having a first temperature and a second fluid region having a second temperature that is different from said first temperature. A heat engine is located within a compartment of the vehicle and configured for converting thermal energy to mechanical energy. The heat engine includes a shape-memory alloy having a crystallographic phase changeable between austenite and martensite in response to the temperature difference between the first fluid region and the second fluid region.

An energy harvesting system includes a fluid, a heat engine, and a component. The fluid has a first fluid region at a first temperature and a second fluid region at a second temperature that is different from the first temperature. The heat engine is configured for converting thermal energy to mechanical energy and includes a shape-memory alloy disposed in heat exchange contact with each of the first fluid region and the second fluid region. The component is driven by the heat engine in response to the temperature difference.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a vehicle having an energy harvesting system;

FIG. 2 is a perspective view of a first embodiment of the energy harvesting system of FIG. 1;

FIG. 3 is a perspective view of a second embodiment of the energy harvesting system of FIG. 1; and

FIG. 4 is a perspective view of a third embodiment of the energy harvesting system of FIG. 1.

### DESCRIPTION OF THE PREFERRED EMBODIMENTS

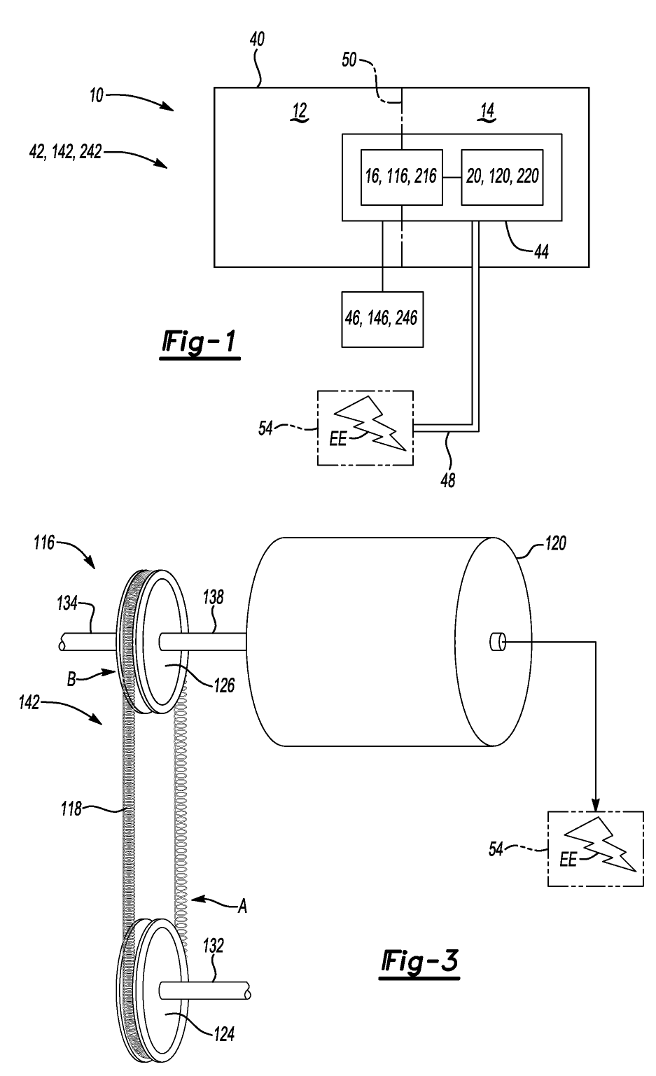

Referring to the Figures, wherein like reference numerals refer to like elements, a vehicle is shown generally at 10 in FIG. 1. The vehicle 10 includes an energy harvesting system 42. The energy harvesting system 42 utilizes the temperature difference between a first fluid region 12 and a second fluid region 14 to generate mechanical or electrical energy, and therefore may be useful for automotive applications. However, it is to be appreciated that the energy harvesting system 42 may also be useful for non-automotive applications such as, but not limited to, household and industrial heating applications.

The vehicle 10 defines a compartment 40 which may house power and drive sources for the vehicle 10, such as an engine and transmission (not shown). The compartment 40 may or may not be enclosed from the surrounding environment, and may include regions and components exterior to the vehicle 10 such as exhaust pipe and catalytic converter, shock absorbers, brakes, and any other region where energy is dissipated as heat proximate to or in the vehicle 10 such as in a passenger compartment or a battery compartment (such as in an electric vehicle).

The energy harvesting system 42 is at least partially located within the compartment 40. The power and drive sources (not shown) for the vehicle 10 typically generate heat. Therefore, the compartment 40 includes the first fluid region 12 and the second fluid region 14 having a temperature difference therebetween. The first fluid region 12 and the second fluid region 14 may be spaced apart from one another, or a sufficient heat exchange barrier 50, such as a heat shield, may be employed to separate the compartment 40 into the first fluid region 12 and the second fluid region 14. The fluid within the energy harvesting system 42 forming the first fluid region 12 and the second fluid region 14 may be selected from a group of gases, liquids, fluidized beds of solids, and combinations thereof. In the embodiment discussed above where the compartment 40 is an engine compartment, fluid within the first fluid region 12 and the second fluid region 14 is air within the compartment 40.

Several examples within a vehicle 10 where the energy harvesting system 42 may take advantage of temperature differentials are proximity to a catalytic converter, next to a battery for the vehicle or within a battery compartment for electric vehicles, proximate to a transmission, brakes, or components of the vehicle suspension in particular a shock absorber, or proximate to or incorporated within a heat exchanger, such as a radiator. The above examples list areas of the vehicle 10 which may act as one of the first fluid region 12 or the second fluid region 14. The energy harvesting system 42 may be positioned such that the other of the first fluid region 12 or the second fluid region 14 is located remotely or separated by a sufficient heat exchange barrier 50 to provide the required temperature differential. The above list contains only examples of where the energy harvesting system 10 may be located and is not intended to be all inclusive of arrangements for the energy harvesting system 42. One skilled in the art would be able to determine areas having an associated temperature differential and an appropriate position for the energy harvesting system 42 to take advantage of the temperature differences.

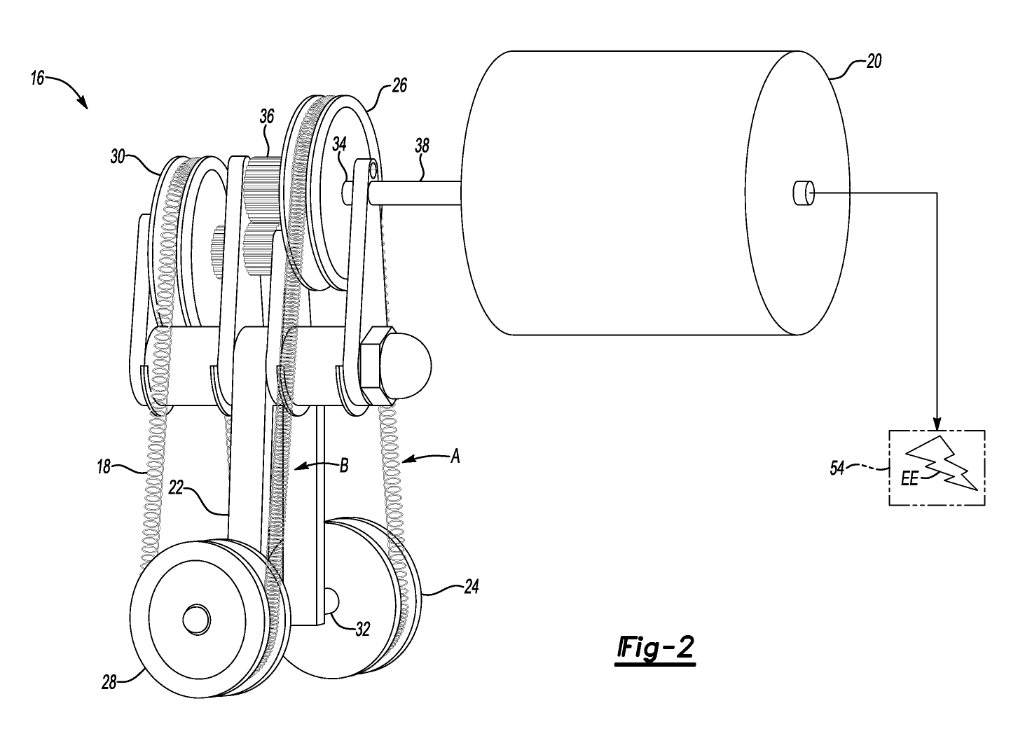

Referring now to FIGS. 1 and 2, the energy harvesting system 42 includes a heat engine 16. The heat engine 16 is configured for converting thermal energy, e.g., heat, to mechanical or heat to mechanical and then to electrical energy, as set forth in more detail below. More specifically, the heat engine 16 includes a shape-memory alloy 18 (FIG. 2) having a crystallographic phase changeable between austenite and martensite in response to the temperature difference of the first fluid region 12 and the second fluid region 14 (FIG. 1).

As used herein, the terminology “shape-memory alloy” refers to alloys which exhibit a shape-memory effect. That is, the shape-memory alloy 18 may undergo a solid state phase change via molecular rearrangement to shift between a martensite phase, i.e., “martensite”, and an austenite phase, i.e., “austenite”. Stated differently, the shape-memory alloy 18 may undergo a displacive transformation rather than a diffusional transformation to shift between martensite and austenite. In general, the martensite phase refers to the comparatively lower-temperature phase and is often more deformable than the comparatively higher-temperature austenite phase. The temperature at which the shape-memory alloy 18 begins to change from the austenite phase to the martensite phase is known as the martensite start temperature, Mₛ. The temperature at which the shape-memory alloy 18 completes the change from the austenite phase to the martensite phase is known as the martensite finish temperature, M_{f}. Similarly, as the shape-memory alloy 18 is heated, the temperature at which the shape-memory alloy 18 begins to change from the martensite phase to the austenite phase is known as the austenite start temperature, Aₛ. And, the temperature at which the shape-memory alloy 18 completes the change from the martensite phase to the austenite phase is known as the austenite finish temperature, A_{f}.

Therefore, the shape-memory alloy 18 may be characterized by a cold state, i.e., when a temperature of the shape-memory alloy 18 is below the martensite finish temperature M_{f} of the shape-memory alloy 18. Likewise, the shape-memory alloy 18 may also be characterized by a hot state, i.e., when the temperature of the shape-memory alloy 18 is above the austenite finish temperature A_{f} of the shape-memory alloy 18.

In operation, i.e., when exposed to the temperature difference of first fluid region 12 and the second fluid region 14, the shape-memory alloy 18, if pre-strained or subjected to tensile stress, can change dimension upon changing crystallographic phase to thereby convert thermal energy to mechanical energy. That is, the shape-memory alloy 18 may change crystallographic phase from martensite to austenite and thereby dimensionally contract if pseudoplastically pre-strained so as to convert thermal energy to mechanical energy. Conversely, the shape-memory alloy 18 may change crystallographic phase from austenite to martensite and if under stress thereby dimensionally expand so as to be returned to a pseudoplastically prestrained state and reset for another cycle of converting thermal energy to mechanical energy. That is, the shape-memory alloy 18 may dimensionally expand if under stress to convert thermal energy to mechanical energy.

The terminology “pseudoplastically pre-strained” refers to stretching the shape-memory alloy element 18 while the shape-memory alloy element 18 is in the martensite phase so that the strain exhibited by the shape-memory alloy element 18 under loading is not fully recovered when unloaded. That is, upon unloading, the shape-memory alloy element 18 appears to have plastically deformed, but when heated to the austenite start temperature, Aₛ, the strain can be recovered so that the shape-memory alloy element 18 returns to the original length observed prior to any load being applied. Additionally, the shape-memory alloy element 18 may be stretched before installation in the heat engine 16, such that the nominal length of the shape-memory alloy 18 includes that recoverable pseudoplastic strain, which provides the motion used for driving the heat engine 16.

The shape-memory alloy 18 may have any suitable composition. In particular, the shape-memory alloy 18 may include an element selected from the group including cobalt, nickel, titanium, indium, manganese, iron, palladium, zinc, copper, silver, gold, cadmium, tin, silicon, platinum, gallium, and combinations thereof. For example, suitable shape-memory alloys 18 may include nickel-titanium based alloys, nickel-aluminum based alloys, nickel-gallium based alloys, indium-titanium based alloys, indium-cadmium based alloys, nickel-cobalt-aluminum based alloys, nickel-manganese-gallium based alloys, copper based alloys (e.g., copper-zinc alloys, copper-aluminum alloys, copper-gold alloys, and copper-tin alloys), gold-cadmium based alloys, silver-cadmium based alloys, manganese-copper based alloys, iron-platinum based alloys, iron-palladium based alloys, and combinations thereof. The shape-memory alloy 18 can be binary, ternary, or any higher order so long as the shape-memory alloy 18 exhibits a shape memory effect, e.g., a change in shape orientation, damping capacity, and the like. A skilled artisan may select the shape-memory alloy 18 according to desired operating temperatures within the compartment 40 (FIG. 1), as set forth in more detail below. In one specific example, the shape-memory alloy 18 may include nickel and titanium.

Further, the shape-memory alloy 18 may have any suitable form, i.e., shape. For example, the shape-memory alloy 18 may have a form selected from the group including springs, tapes, wires, bands, continuous loops, and combinations thereof. Referring to FIG. 2, in one variation, the shape-memory alloy 18 may be formed as a continuous loop spring.

The shape-memory alloy 18 may convert thermal energy to mechanical energy via any suitable manner. For example, the shape-memory alloy 18 may activate a pulley system (shown generally in FIG. 2 and set forth in more detail below), engage a lever (not shown), rotate a flywheel (not shown), engage a screw (not shown), and the like.

Referring again to FIGS. 1 and 2, the energy harvesting system 42 also includes a driven component 20. The component 20 may be a simple mechanical device, selected from a group including a fan, a belt, a clutch drive, a blower, a pump, a compressor and combinations thereof. The component 20 is driven by the heat engine 16. The component 20 may be part of an existing system within the vehicle 10 such as a heating or cooling system. The mechanical energy may drive the component 20 or may assist other systems of the vehicle 10 in driving the component 20. Driving the component 20 with power provided by the heat engine 16 may also allow an associated existing system within the vehicle 10 to be decreased in size/capacity. In the example above, the heat engine 16 may assist in driving a fan for the heating/cooling system allowing the main heating cooling system capacity to be decreased and providing weight savings in addition to the energy savings.

Alternately, the component 20 may be a generator. The component/generator 20 is configured for converting mechanical energy from the heat engine 16 to electricity (represented generally by symbol EE in FIGS. 1 and 2). The component/generator 20 may be any suitable device for converting mechanical energy to electricity EE. For example, the component/generator 20 may be an electrical generator that converts mechanical energy to electricity EE using electromagnetic induction, and may include a rotor (not shown) that rotates with respect to a stator (not shown). The electrical energy from the component/generator 20 may than be used to assist in powering the main or accessory drive systems within the vehicle 10.

Referring to FIG. 2, the component 20 is driven by the heat engine 16. That is, mechanical energy resulting from the conversion of thermal energy by the shape-memory alloy 18 may drive the component 20. In particular, the aforementioned dimensional contraction and the dimensional expansion of the shape-memory alloy 18 coupled with the changes in modulus may drive the component 20.

More specifically, in one variation shown in FIG. 2, the heat engine 16 may include a frame 22 configured for supporting one or more wheels 24, 26, 28, 30 disposed on a plurality of axles 32, 34. The wheels 24, 26, 28, 30 may rotate with respect to the frame 22, and the shape-memory alloy 18 may be supported by, and travel along, the wheels 24, 26, 28, 30. Speed of rotation of the wheels 24, 26, 28, 30 may optionally be modified by one or more gear sets 36. Moreover, the component 20 may include a drive shaft 38 attached to the wheel 26. As the wheels 24, 26, 28, 30 turn about the axles 32, 34 of the heat engine 16 in response to the dimensionally expanding and contracting shape-memory alloy 18 and the accompanying changes in modulus, the drive shaft 38 rotates and drives the component 20.

Referring again to FIG. 1, the energy harvesting system is shown generally at 42. The energy harvesting system 42 is configured for generating mechanical or electric energy. More specifically, the energy harvesting system 42 includes the first fluid region 12 having a first temperature and the second fluid region 14 having a second temperature that is different from the first temperature. For example, the first temperature may be higher than the second temperature. The temperature difference between the first temperature and the second temperature may be as little as about 5° C. and no more than about 300° C.

The heat engine 16, and more specifically, the shape-memory alloy 18 (FIG. 2) of the heat engine 16, is disposed in thermal contact or heat exchange relation with each of the first fluid region 12 and the second fluid region 14. Therefore, the shape-memory alloy 18 may change crystallographic phase between austenite and martensite upon thermal contact or heat exchange relation with one of the first fluid region 12 and the second fluid region 14. For example, upon contact with the first fluid region 12, the shape-memory alloy 18 may change from martensite to austenite. Likewise, upon contact with the second fluid region 14, the shape-memory alloy 18 may change from austenite to martensite.

Further, the shape-memory alloy 18 may change both modulus and dimension upon changing crystallographic phase to thereby convert thermal energy to mechanical energy. More specifically, the shape-memory alloy 18, if pseudoplastically pre-strained may dimensionally contract upon changing crystallographic phase from martensite to austenite and may dimensionally expand, if under tensile stress, upon changing crystallographic phase from austenite to martensite to thereby convert thermal energy to mechanical energy. Therefore, for any condition wherein the temperature difference exists between the first temperature of the first fluid region 12 and the second temperature of the second fluid region 14, i.e., wherein the first fluid region 12 and the second fluid region 14 are not in thermal equilibrium, the shape-memory alloy 18 may dimensionally expand and contract upon changing crystallographic phase between martensite and austenite. And, the change in crystallographic phase of the shape-memory alloy 18 may cause the shape-memory alloy to rotate the pulleys 24, 26, 28, 30 (shown in FIG. 2) and, thus, drive the component 20.

In operation, with reference to the heat exchange system 42 of FIG. 1 and described with respect to the example configuration of the shape-memory alloy 18 shown in FIG. 2, one wheel 28 may be immersed in or in heat exchange relation with the first fluid region 12 while another wheel 24 may be immersed in or in heat exchange relation with the second fluid region 14. As one area (generally indicated by arrow A) of the shape-memory alloy 18 dimensionally expands when under stress and in contact with the second fluid region 14, another area (generally indicated by arrow B) of the shape-memory alloy 18 that is pseudoplastically pre-strained in contact with the first fluid region 12 dimensionally contracts. Alternating dimensional contraction and expansion of the continuous spring loop form of the shape-memory alloy 18 upon exposure to the temperature difference between the first fluid region 12 and the second fluid region 14 can cause the shape memory alloy 18 to convert potential mechanical energy to kinetic mechanical energy, thereby driving the pulleys 24, 26, 28, 30 and converting thermal energy to mechanical energy.

The heat engine 16 and the component/generator 20 may be disposed within the compartment 40 of the vehicle 10. In particular, the heat engine 16 and component 20 may be disposed in any location within and proximate to the vehicle 10 as long as the shape-memory alloy 18 is disposed in thermal contact or heat exchange relation with each of the first fluid region 12 and the second fluid region 14. Further, the heat engine 16 and the component 20 may be surrounded by a vented housing 44 (FIG. 1). The housing 44 may define cavities (not shown) through which electronic components, such as wires may pass. A barrier 50 may be located within the housing 44 to separate the first fluid region 12 from the second fluid region 14.

Referring now to FIG. 1, in one variation, the energy harvesting system 42 also includes an electronic control unit 46. The electronic control unit 46 is in operable communication with the vehicle 10. The electronic control unit 46 may be, for example, a computer that electronically communicates with one or more controls and/or sensors of the energy harvesting system 42. For example, the electronic control unit 46 may communicate with and/or control one or more of a temperature sensor within the first fluid region 12, a temperature sensor within the second fluid region 14, a speed regulator of the component 20, fluid flow sensors, and meters configured for monitoring electricity generation. The electronic control unit 46 may control the harvesting of energy under predetermined conditions of the vehicle 10. For example, after the vehicle 10 has operated for a sufficient period of time to ensure that a temperature differential between the first fluid region 12 and the second fluid region 14 is at an optimal difference. An electronic control unit 46 may also provide the option to manually override the heat engine 16 to allow the energy harvesting system 42 to be turned off. A clutch (not shown) controlled by the electronic control unit 46 may be used to disengage the heat engine 16 from the component 20.

As also shown in FIG. 1, the energy harvesting system 42 includes a transfer medium 48 configured for conveying electricity EE from the energy harvesting system 42. In particular, the transfer medium 48 may convey electricity EE from the component/generator 20. The transfer medium 48 may be, for example, a power line or an electrically-conductive cable. The transfer medium 48 may convey electricity EE from the component/generator 20 to a storage device 54, e.g., a battery for the vehicle. The storage device 54 may also be located proximate to but separate from the vehicle 10. Such a storage device 54 may allow the energy harvesting system 42 to be utilized with a parked vehicle such as 10. For example, the energy harvesting system 42 may take advantage of a temperature differential created by sun load on a hood for the compartment 40 and store the electrical energy EE generated in the storage device 54.

Whether the energy from the energy harvesting system 42 is used to drive a component 20 directly or stored for later usage the energy harvesting system 42 provides additional energy to the vehicle 10 and reduces the load on the main energy sources for driving the vehicle 10. Thus, the energy harvesting system 42 increases the fuel economy and range for the vehicle 10. As described above, the energy harvesting system 42 may operate autonomously requiring no input from the vehicle 10.

It is to be appreciated that for any of the aforementioned examples, the vehicle 10 and/or the energy harvesting system 42 may include a plurality of heat engines 16 and/or a plurality of components 20. That is, one vehicle 10 may include more than one heat engine 16 and/or component 20. For example, one heat engine 16 may drive more than one component 20. Likewise, vehicle 10 may include more than one energy harvesting system 42, each including at least one heat engine 16 and component 20. Multiple heat engines 16 may take advantage of multiple regions of temperature differentials throughout the vehicle.

Referring to the FIG. 3, a second embodiment of a heat engine 116 for an energy harvesting system 142 is illustrated. The heat engine 116 is configured for converting thermal energy, e.g., heat, to mechanical or electrical energy. More specifically, the heat engine 116 includes a shape-memory alloy 118 having a crystallographic phase changeable between austenite and martensite in response to the temperature difference of the first fluid region 12 and the second fluid region 14 (FIG. 1). The shape-memory alloy 118 operates in a similar manner to the shape-memory allow 18 as described above. Further, the shape-memory alloy 118 may have any suitable form, i.e., shape. For example, the shape-memory alloy 118 may have a form selected from the group including springs, tapes, wires, bands, continuous loops, and combinations thereof.

The energy harvesting system 142 also includes a driven component 120. The component 120 may be a simple mechanical device, which is driven by the heat engine 116. The component 120 may be part of an existing system within the vehicle 10. The mechanical energy may drive the component 120 or may assist other systems of the vehicle 10 in driving the component 120. Driving the component 120 with power provided by the heat engine 116 may also allow an associated existing system within the vehicle 10 to be decreased in size/capacity.

Alternately, the component 120 may be a generator. The component/generator 120 is configured for converting mechanical energy from the heat engine 116 to electricity (represented generally by symbol EE). The electrical energy from the component/generator 120 may than be used to assist in powering the main or accessory drive systems within the vehicle 10 (shown in FIG. 1).

The component 120 is driven by the heat engine 116. That is, mechanical energy resulting from the conversion of thermal energy by the shape-memory alloy 118 may drive the component 120. In particular, the aforementioned dimensional contraction and the dimensional expansion of the shape-memory alloy 118 in combination with the accompanying change in modulus may drive the component 120.

More specifically, the heat engine 116 may include wheels 124 and 126 disposed on a plurality of axles 132 and 134. The axles 132 and 134 may be supported by various components of the vehicle 10. The wheels 124 and 126 may rotate with respect to the vehicle 10 components, and the shape-memory alloy 118 may be supported by, and travel along, the wheels 124 and 126. The component 120 may include a drive shaft 138 attached to the wheel 126. As the wheels 124 and 126 turn about the axles 132 and 134 in response to the dimensionally expanding and contracting shape-memory alloy 118 and the accompanying changes in its modulus, the drive shaft 138 rotates and drives the component 120.

Referring to FIGS. 1 and 3, the heat engine 116, and more specifically, the shape-memory alloy 118 of the heat engine 116, is disposed in thermal contact or heat exchange relation with each of the first fluid region 12 and the second fluid region 14. Therefore, the shape-memory alloy 118 may change crystallographic phase between austenite and martensite upon contact with one of the first fluid region 12 and the second fluid region 14. For example, upon contact with the first fluid region 12, the shape-memory alloy 18 may change from martensite to austenite. Likewise, upon contact with the second fluid region 14, the shape-memory alloy 118 may change from austenite to martensite.

Further, the shape-memory alloy 118 may change dimension upon changing crystallographic phase to thereby convert thermal energy to mechanical energy. More specifically, the shape-memory alloy 118 may dimensionally contract when pseudoplastically pre-strained upon changing crystallographic phase from martensite to austenite and may dimensionally expand when under tensile stress upon changing crystallographic phase from austenite to martensite to thereby convert thermal energy to mechanical energy. Therefore, for any condition wherein the temperature difference exists between the first temperature of the first fluid region 12 and the second temperature of the second fluid region 14, i.e., wherein the first fluid region 12 and the second fluid region 14 are not in thermal equilibrium, the shape-memory alloy 118 may dimensionally expand and contract and experience an accompanying change in modulus upon changing crystallographic phase between martensite and austenite. And, the change in crystallographic phase of the shape-memory alloy 118 may cause the shape-memory alloy to rotate the pulleys 124 and 126 and, thus, drive the component/generator 120.

In operation one wheel 128 may be immersed in or in heat exchange relation with the first fluid region 12 while another wheel 124 may be immersed in or in heat exchange relation with the second fluid region 14. As one area (generally indicated by arrow A) of the shape-memory alloy 118 under applied tensile stress dimensionally expands when in contact with the second fluid region 14, another area (generally indicated by arrow B) of the shape-memory alloy 118 that is pseudoplastically pre-strained and in contact with the first fluid region 12 dimensionally contracts. Alternating dimensional contraction and expansion of the continuous spring loop form of the shape-memory alloy 18 along with the accompanying change in modulus upon exposure to the temperature difference between the first fluid region 12 and the second fluid region 14 may cause the shape memory alloy 118 to convert potential mechanical energy to kinetic mechanical energy, thereby driving the pulleys 124 and 126 and converting thermal energy to mechanical energy.

The heat engine 116 and the component 120 may be disposed within the compartment 40 of the vehicle 10. In particular, the heat engine 116 and component 120 may be disposed in any location within the vehicle 10 as long as the shape-memory alloy 118 is disposed in contact with each of the first fluid region 12 and the second fluid region 14. As described above, the heat engine 116 and the component/generator 120 may be surrounded by a vented housing 44. The housing 44 may define cavities (not shown) through which electronic components, such as wires may pass. A sufficient heat exchange barrier 50 may be located within the housing 44 to separate the first fluid region 12 from the second fluid region 14.

In one variation, the energy harvesting system 142 also includes an electronic control unit 46. The electronic control unit 146 is in operable communication with the vehicle 10. The electronic control unit 146 may be, for example, a computer that electronically communicates with one or more controls and/or sensors of the energy harvesting system 142. For example, the electronic control unit 146 may communicate with and/or control one or more of a temperature sensor within the first fluid region 12, a temperature sensor within the second fluid region 14, a speed regulator of the component/generator 120, fluid flow sensors, and meters configured for monitoring electricity generation. The electronic control unit 146 may control the harvesting of energy under predetermined conditions of the vehicle 10. For example, after the vehicle 10 has operated for a sufficient period of time to ensure that a temperature differential between the first fluid region 12 and the second fluid region 14 is at an optimal difference. An electronic control unit 146 may also provide the option to manually override the heat engine 116 to allow the energy harvesting system 142 to be turned off A clutch (not shown) controlled by the electronic control unit 146 may be used to disengage the heat engine 116 from the component 120.

As also shown in FIG. 1, the energy harvesting system 142 includes a transfer medium 48 configured for conveying electricity EE from the energy harvesting system 142. In particular, the transfer medium 48 may convey electricity EE from the component 120. The transfer medium 48 may be, for example, a power line or an electrically-conductive cable. The transfer medium 48 may convey electricity EE from the generator 120 to a storage device 54, e.g., a battery for the vehicle. The storage device 54 may be located proximate to but separate from the vehicle 10. Such a storage device 54 may allow the energy harvesting system 142 to be utilized with a parked vehicle 10. For example, the energy harvesting system 142 may take advantage of a temperature differential created by sun load on a hood for the compartment 40 and store the electrical energy EE generated in the storage device 54.

Whether the energy from the energy harvesting system 142 is used to drive a component 120 directly or stored for later usage the energy harvesting system 142 provides additional energy to the vehicle 10 and reduces the load on the main energy source for driving the vehicle 10. Thus, the energy harvesting system 142 increases the fuel economy and range for the vehicle 10. As described above, the energy harvesting system 142 may operate autonomously requiring no input from the vehicle 10.

It is to be appreciated that for any of the aforementioned examples, the vehicle 10 and/or the energy harvesting system 142 may include a plurality of heat engines 116 and/or a plurality of components 120. That is, one vehicle 10 may include more than one heat engine 116 and/or component 120. For example, one heat engine 116 may drive more than one component 120. Likewise, vehicle 10 may include more than one energy harvesting system 142, each including at least one heat engine 116 and component 120. Multiple heat engines 116 may take advantage of multiple regions of temperature differentials throughout the vehicle.

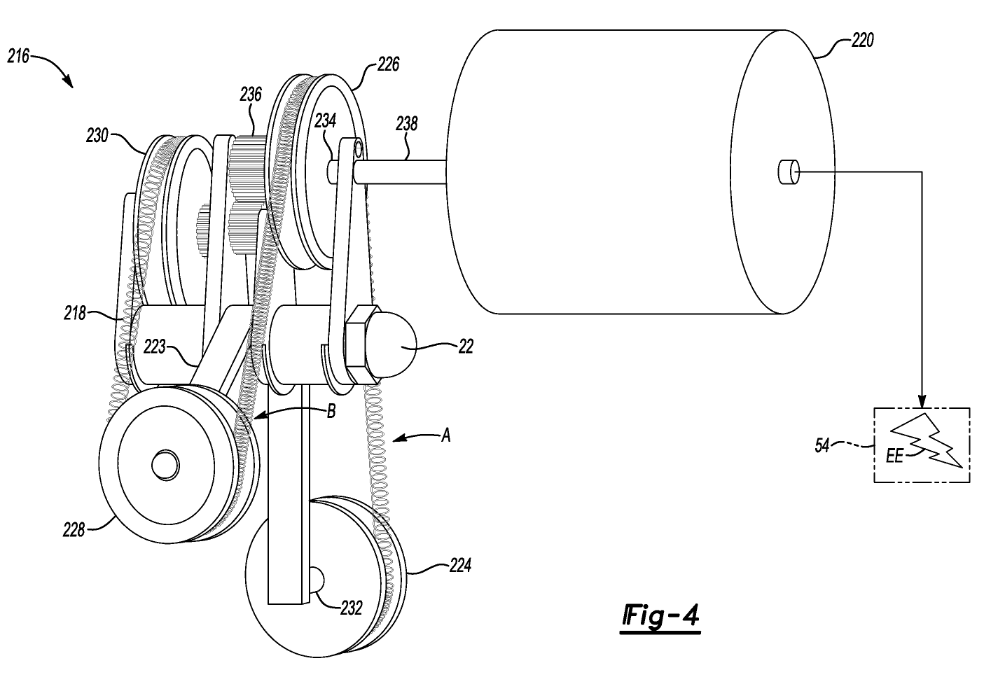

Referring to the FIG. 4, an embodiment of a heat engine 216 for an energy harvesting system 242 is illustrated. The heat engine 216 is configured for converting thermal energy, e.g., heat, to mechanical or electrical energy. More specifically, the heat engine 216 includes a shape-memory alloy 218 having a crystallographic phase changeable between austenite and martensite in response to the temperature difference of the first fluid region 12 and the second fluid region 14 (FIG. 1). The shape-memory alloy 218 operates in a similar manner to the shape-memory allow 18, as described above. Further, the shape-memory alloy 218 may have any suitable form, i.e., shape or configuration. For example, the shape-memory alloy 218 may have a form selected from the group including bias members (such as springs), tapes, wires, bands, continuous loops, and combinations thereof.

The energy harvesting system 242 also includes a driven component 220. The component 220 may be a simple mechanical device, which is driven by the heat engine 216. The component 220 may be part of an existing system within the vehicle 10. The mechanical energy may drive the component 220 or may assist other systems of the vehicle 10 in driving the component 220. Driving the component 220 with power provided by the heat engine 216 may also allow an associated existing system within the vehicle 10 to be decreased in size/capacity.

Alternately, the component 220 may be a generator. The component/generator 220 is configured for converting mechanical energy from the heat engine 216 to electricity (represented generally by symbol EE). The electrical energy from the component/generator 220 may than be used to assist in powering the main or accessory drive systems within the vehicle 10 (shown in FIG. 1).

The component 220 is driven by the heat engine 216. That is, mechanical energy resulting from the conversion of thermal energy by the shape-memory alloy 218 may drive the component 220. In particular, the aforementioned dimensional contraction and the dimensional expansion of the shape-memory alloy 218 with the accompanying changes in modulus may drive the component 220.

More specifically, in one variation shown in FIG. 4, the heat engine 216 may include a frame 222 configured for supporting one or more wheels 224, 226, 228, 230 disposed on a plurality of axles 232, 234. The wheels 224, 226, 228, 230 may rotate with respect to the frame 222, and the shape-memory alloy 218 may be supported by, and travel along, the wheels 224, 226, 228, 230. Speed of rotation of the wheels 224, 226, 228, 230 may optionally be modified by one or more gear sets 236. Moreover, the generator 220 may include a drive shaft 238 attached to the wheel 226. As the wheels 224, 226, 228, 230 turn about the axles 232, 234 of the heat engine 216 in response to the dimensionally expanding and contracting shape-memory alloy 218, the drive shaft 238 rotates and drives the component 220.

The frame 222 may include a cantilevered support arm 223 to allow the wheels 224 and 228 to be spaced apart from one another or to allow various components of the vehicle 10 to be located between the wheels 224 and 228. Alternatively, the heat engine 16 may not include a frame 222 and the wheels 224, 226, 228, 230 may be individually supported on various components of the vehicle 10 in an arrangement that maintains alignment of the wheels 224, 226, 228, 230 to allow rotation as a result of the shape-memory alloy 218. Therefore, the heat engine 216 may be packaged within the compartment 40 (shown in FIG. 1) in an arrangement that is suited for a particular vehicle 10.

Referring to FIGS. 1 and 4, the heat engine 216, and more specifically, the shape-memory alloy 218 of the heat engine 216, is disposed in contact with each of the first fluid region 12 and the second fluid region 14. Therefore, the shape-memory alloy 218 may change crystallographic phase between austenite and martensite upon contact with one of the first fluid region 12 and the second fluid region 14. For example, upon contact with the first fluid region 12, the shape-memory alloy 218 may change from martensite to austenite. Likewise, upon contact with the second fluid region 14, the shape-memory alloy 218 may change from austenite to martensite.

Further, the shape-memory alloy 218 may change dimension upon changing crystallographic phase to thereby convert thermal energy to mechanical energy. More specifically, the shape-memory alloy 218 may dimensionally contract when pseudoplastically pre-strained upon changing crystallographic phase from martensite to austenite and may dimensionally expand when under tensile stress upon changing crystallographic phase from austenite to martensite to thereby convert thermal energy to mechanical energy. Therefore, for any condition wherein the temperature difference exists between the first temperature of the first fluid region 12 and the second temperature of the second fluid region 14, i.e., wherein the first fluid region 12 and the second fluid region 14 are not in thermal equilibrium, the shape-memory alloy 118 may dimensionally expand and contract upon changing crystallographic phase between martensite and austenite. And, the change in crystallographic phase of the shape-memory alloy 218 may cause the shape-memory alloy to rotate the pulleys 224, 226, 228, 230 and, thus, drive the component 220.

In operation one wheel 228 may be immersed in or in heat exchange relation with the first fluid region 12 while another wheel 224 may be immersed in or in heat exchange relation with the second fluid region 14. As one area (generally indicated by arrow A) of the shape-memory alloy 118 that is under tensile stress dimensionally expands when in contact with the second fluid region 14, another area (generally indicated by arrow B) of the shape-memory alloy 218 in contact with the first fluid region 12 that is pseudoplastically pre-strained dimensionally contracts. Alternating dimensional contraction and expansion coupled with changes in the modulus of the continuous spring loop form of the shape-memory alloy 218 upon exposure to the temperature difference between the first fluid region 12 and the second fluid region 14 may cause the shape memory alloy 218 convert potential mechanical energy to kinetic mechanical energy, and thereby driving the pulleys 224, 226, 228, 230 and converting thermal energy to mechanical energy.

The heat engine 216 and the component 220 may be disposed within the compartment 40 of the vehicle 10. In particular, the heat engine 216 and component/generator 220 may be disposed in any location within the vehicle 10 as long as the shape-memory alloy 218 is disposed in thermal contact or heat exchange relation with each of the first fluid region 12 and the second fluid region 14. As described above, the heat engine 216 and the component/generator 220 may be surrounded by a vented housing 44. The housing 44 may define cavities (not shown) through which electronic components, such as wires may pass. A sufficient heat exchange barrier 50 may be located within the housing 44 to separate the first fluid region 12 from the second fluid region 14.

In one variation, the energy harvesting system 242 also includes an electronic control unit 246. The electronic control unit 246 is in operable communication with the vehicle 10. The electronic control unit 246 may be, for example, a computer that electronically communicates with one or more controls and/or sensors of the energy harvesting system 242. For example, the electronic control unit 246 may communicate with and/or control one or more of a temperature sensor within the first fluid region 12, a temperature sensor within the second fluid region 14, a speed regulator of the component 220, fluid flow sensors, and meters configured for monitoring electricity generation. The electronic control unit 246 may control the harvesting of energy under predetermined conditions of the vehicle 10. For example, after the vehicle 10 has operated for a sufficient period of time to ensure that a temperature differential between the first fluid region 12 and the second fluid region 14 is at a sufficient or alternatively an optimal difference. An electronic control unit 246 may also provide the option to manually override the heat engine 216 to allow the energy harvesting system 242 to be turned off. A clutch (not shown) controlled by the electronic control unit 246 may be used to disengage the heat engine 216 from the component/generator 220.

As also shown in FIG. 1, the energy harvesting system 242 includes a transfer medium 48 configured for conveying electricity EE from the energy harvesting system 242. In particular, the transfer medium 48 may convey electricity EE from the component 220. The transfer medium 48 may be, for example, a power line or an electrically-conductive cable. The transfer medium 48 may convey electricity EE from the generator 220 to a storage device 54, e.g., a battery for the vehicle 10. The storage device 54 may be located proximate to but separate from the vehicle 10. Such a storage device may allow the energy harvesting system 242 to be utilized with a parked vehicle 10. For example, the energy harvesting system 242 may take advantage a temperature differential created by sun load on a hood for the compartment 40 and store the electrical energy EE generated in the storage device 54.

Whether the energy from the energy harvesting system 242 is used to drive a component 220 directly or stored for later usage the energy harvesting system 242 provides additional energy to the vehicle 10 and reduces the load on the main energy source for driving the vehicle 10. Thus, the energy harvesting system 242 increases the fuel economy and range for the vehicle 10. As described above, the energy harvesting system 242 may operate autonomously requiring no input from the vehicle 10.

It is to be appreciated that for any of the aforementioned examples, the vehicle 10 and/or the energy harvesting system 242 may include a plurality of heat engines 116 and/or a plurality of components 220. That is, one vehicle 10 may include more than one heat engine 216 and/or component 220. For example, one heat engine 216 may drive more than one component 220. Likewise, vehicle 10 may include more than one energy harvesting system 242, each including at least one heat engine 216 and component 220. Multiple heat engines 216 may take advantage of multiple regions.

While the best modes for carrying out the invention have been described in detail, those familiar with the art to which this invention relates will recognize various alternative designs and embodiments for practicing the invention within the scope of the appended claims.

1. A vehicle comprising:
a first fluid region having a first temperature;
a second fluid region having a second temperature; and
a heat engine configured for converting thermal energy to mechanical energy and including a pseudoplastically pre-strained shape-memory alloy having a crystallographic phase changeable between austenite and martensite in response to a temperature difference between the first fluid region and the second fluid region.

2. The vehicle of claim 1, further comprising a component driven with said mechanical energy from said heat engine.

3. The vehicle of claim 2, wherein the component is selected from a group including a fan, a belt, a clutch drive, a blower, a pump, a compressor and combinations thereof.

4. The vehicle of claim 2, wherein the component is a generator configured for converting mechanical energy to electrical energy.

5. The vehicle of claim 4, further comprising a storage device connected to the generator for storing the electrical energy.

6. The vehicle of claim 2, wherein said change in crystallographic phase of said shape-memory alloy and associated stiffness increase and shape memory effects drive said component.

7. The vehicle of claim 1, wherein said shape-memory alloy changes dimension upon changing crystallographic phase to thereby convert thermal energy to mechanical energy.

8. The vehicle of claim 7, wherein said shape-memory alloy changes crystallographic phase from martensite to austenite and thereby sufficiently dimensionally contracts so as to convert thermal energy to mechanical energy.

9. The vehicle of claim 7, wherein said shape-memory alloy changes crystallographic phase from austenite to martensite and thereby decreases in modulus and when under stress sufficiently dimensionally expands so as to reset said shape-memory alloy for converting thermal energy to mechanical energy.

10. The vehicle of claim 1, wherein said shape-memory alloy has a form selected from the group including springs, tapes, wires, bands, continuous loops, and combinations thereof.

11. The vehicle of claim 1, wherein said shape-memory alloy includes nickel and titanium.

12. An energy harvesting system comprising:
a first fluid region having a first temperature;
a second fluid region having a second temperature that is different from said first temperature;
a heat engine configured for converting thermal energy to mechanical energy and including a pseudoplastically pre-strained shape-memory alloy disposed in heat exchange contact with each of said first fluid region and said second fluid region; and
a component driven by said heat engine in response to said temperature difference between the first fluid region and the second fluid region.

13. The energy harvesting system of claim 12, wherein the component is a generator configured for converting mechanical energy to electricity.

14. The energy harvesting system of claim 13, further comprising a storage device connected to the generator for storing the electrical energy.

15. The energy harvesting system of claim 12, wherein said shape-memory alloy changes crystallographic phase between austenite and martensite upon heat exchange contact with one of said primary fluid and said secondary fluid.

16. The energy harvesting system of claim 12, wherein said change in crystallographic phase of said shape-memory alloy drives said component.

17. The energy harvesting system of claim 16, wherein said shape-memory alloy dimensionally contracts upon changing crystallographic phase from martensite to austenite and sufficiently dimensionally expands under applied tensile stress upon changing crystallographic phase from austenite to martensite to drive said component.

18. The energy harvesting system of claim 16, wherein said shape-memory alloy changes crystallographic phase from austenite to martensite, and when under stress sufficiently dimensionally expands so as to reset said shape-memory alloy for converting thermal energy to mechanical energy.

19. The energy harvesting system of claim 12, wherein a temperature difference between said first temperature and said second temperature is less than or equal to about 300° C.

20. The energy harvesting system of claim 12, wherein an electronic control unit is controllably connected to control at least one of the heat engine and the component.
